(19) United States
(12) Patent Application Publication
(10) Pub. No.: US 2024/0323977 A1
(43) Pub. Date: Sep. 26, 2024

(54) PDCCH DETECTION METHOD, TERMINAL DEVICE, NETWORK DEVICE, AND STORAGE MEDIUM

(71) Applicant: GUANGDONG OPPO MOBILE TELECOMMUNICATIONS CORP., LTD., Dongguan (CN)

(72) Inventors: Jing XU, Dongguan (CN); Bin LIANG, Dongguan (CN)

(21) Appl. No.: 18/731,637

(22) Filed: Jun. 3, 2024

Related U.S. Application Data
(63) Continuation of application No. PCT/CN2021/144057, filed on Dec. 31, 2021.

(51) Int. Cl. H04W 72/232

(52) U.S. Cl. CPC H04W 72/232

(57) ABSTRACT

Provided are a PDCCH detection method, a terminal device, a network device, and a storage medium, which are related to the technical field of wireless communication. The PDCCH detection method includes: a terminal device performing blind detection on the basis of a PDCCH configuration issued by a network device, and obtaining target downlink control information (DCI) (S200), wherein the PDCCH configuration corresponds to a target carrier combination set, the target carrier combination set comprises one or more carrier combinations, one carrier combination comprises one or more carriers, and the target DCI is used for scheduling one carrier combination in the target carrier combination set. The PDCCH detection method enables identification and acquisition of DCI corresponding to a terminal device.

### CROSS-REFERENCE TO RELATED APPLICATION

This application is a continuation application of International Patent Application No. PCT/CN2021/144057 filed on Dec. 31, 2021, the entire contents of which are incorporated herein by reference.

### TECHNICAL FIELD

The present disclosure relates to the technical field of wireless communications, in particular to a method for physical downlink control channel (PDCCH) detection, a terminal device, a network device, and a storage medium.

### BACKGROUND

In wireless communication systems, a PDCCH is used for carrying downlink control information (DCI). A base station sends DCI to user equipment (UE, which may also be called as a terminal device) through a PDCCH, and indicates a scheduling resource corresponding to the UE through the DCI. For example, the base station may indicate a physical downlink shared channel (PDSCH) resource, a physical uplink shared channel (PUSCH) resource, etc.

However, multiple DCIs may be included in a bandwidth region of a PDCCH, and UE needs to identify a DCI for itself. Therefore, it is necessary to propose a PDCCH detection solution to detect the DCI corresponding to the UE.

### SUMMARY

Accordingly, the present disclosure provides a method for PDCCH detection, a terminal device, a network device, and a storage medium.

In a first aspect, there is provided a method for PDCCH detection in an embodiment of the present disclosure, the method includes the following operation.

A terminal device performs blind detection based on a PDCCH configuration sent by a network device, to obtain target DCI.

The PDCCH configuration corresponds to a target carrier combination group, the target carrier combination group includes one or more carrier combinations, and each carrier combination includes one or more carriers. The target DCI is for scheduling a carrier combination in the target carrier combination group.

In a second aspect, there is provided a terminal device in an embodiment of the present disclosure. The terminal device includes a processor and a detector.

The detection detector is configured to perform blind detection under control of the processor based on a PDCCH configuration sent by a network device, to obtain target DCI.

The PDCCH configuration corresponds to a target carrier combination group, the target carrier combination group includes one or more carrier combinations, and each carrier combination includes one or more carriers. The target DCI is for scheduling a carrier combination in the target carrier combination group.

In a third aspect, there is provided a network device in an embodiment of the present disclosure. The network device includes a processor and a transceiver.

The transceiver is configured to send a PDCCH configuration for a target carrier combination group to a terminal device.

The PDCCH configuration corresponds to the target carrier combination group, the target carrier combination group includes one or more carrier combinations, and each carrier combination includes one or more carriers. The PDCCH configuration is configured for the terminal device to perform blind detection on a PDCCH based on the PDCCH configuration to obtain target DCI, and the target DCI is for scheduling a carrier combination in the target carrier combination group.

### BRIEF DESCRIPTION OF THE DRAWINGS

FIG. 1 is a schematic diagram of an implementation environment of a method for PDCCH detection provided in an embodiment.

FIG. 2 is a schematic diagram of a method for PDCCH detection provided in an embodiment.

FIG. 3 is a schematic diagram of a scheduling relationship among multiple groups of carrier combinations provided in an embodiment.

FIG. 4 is a schematic diagram of a scheduling relationship among multiple groups of carrier combinations provided in another embodiment.

FIG. 5 is a schematic diagram of a scheduling relationship among multiple groups of carrier combinations provided in another embodiment.

FIG. 6 is a schematic diagram of alignment of DCI formats provided in an embodiment.

FIG. 7 is a schematic diagram of determination of a total capability corresponding to a target parameter set provided in an embodiment.

FIG. 8 is a schematic diagram of determination of a total capability corresponding to a target parameter set provided in another embodiment.

FIG. 9 is a block diagram of a terminal device provided in an embodiment.

FIG. 10 is a block diagram of a network device provided in another embodiment.

FIG. 11 is a block diagram of a communication device provided in an embodiment.

FIG. 12 is a block diagram of a chip provided in an embodiment.

### DETAILED DESCRIPTION

In order to make the purpose, technical solution and advantages of the present disclosure more clear, the present disclosure will be described in further detail below with reference to the accompanying drawings and embodiments. It should be understood that the specific embodiments described herein are only to explain the present application and are not intended to limit the present application.

In wireless communication systems, a PDCCH is used for carrying DCI. A base station may send DCI to UE through a PDCCH, and indicate a scheduling resource corresponding to the UE through the DCI. For example, the base station may indicate a PDSCH resource, a PUSCH resource, etc.

However, multiple DCIs may be included in a bandwidth region of a PDCCH, and UE needs to identify a DCI for itself. Therefore, a PDCCH detection solution is proposed to detect the DCI of the UE.

Accordingly, the embodiments of the present disclosure provide a method for PDCCH detection. A terminal device performs blind detection based on a PDCCH configuration sent by a network device, to obtain target DCI. The PDCCH configuration corresponds to a target carrier combination group, the target carrier combination group includes one or more carrier combinations, each carrier combination includes one or more carriers, and the target DCI is for scheduling a carrier combination in the target carrier combination group. In such way, the target carrier combination group is configured with a corresponding PDCCH configuration, and the terminal device performs the blind detection based on the PDCCH configuration of the target carrier combination group, to obtain the target DCI for the terminal device. Therefore, identification and acquisition of the DCI for the terminal device can be achieved.

An implementation environment associated with the method for PDCCH detection provided by the embodiments of the present disclosure will be briefly described below.

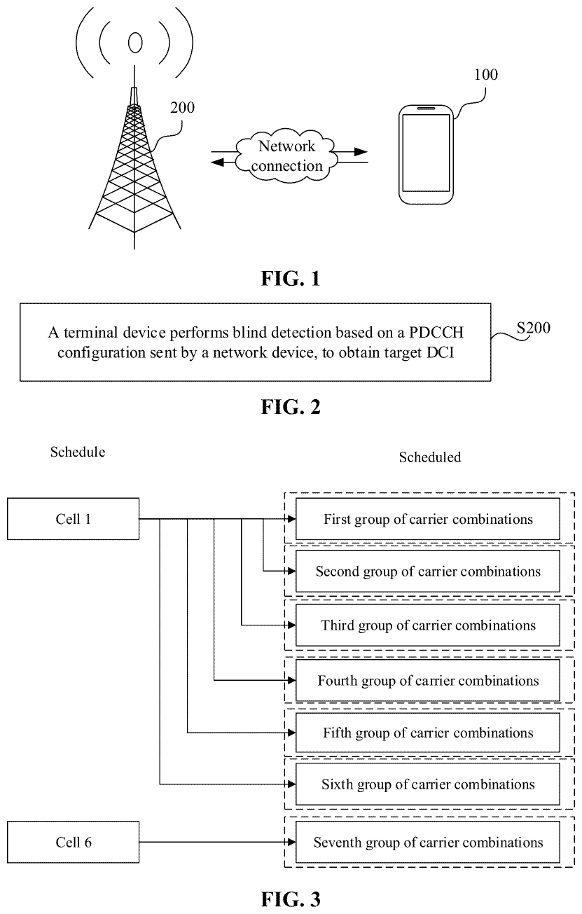

In some embodiments, as shown in FIG. 1, the implementation environment may include a terminal device 100 and a network device 200, and the terminal device 100 and the network device 200 may communicate with each other through a network.

The terminal device 100 may be a personal digital assistant (PDA), a handheld device with a wireless communication function, a computing device or other processing devices connected to a wireless modem, an on-board device, a wearable device, user equipment in a 5th generation (5G) network or user equipment in a future evolved public land mobile network (PLMN) network, etc. The network device 200 may be any type of base station device such as a macro base station, a micro base station, or a pico base station.

With reference to FIG. 2, FIG. 2 illustrates a method for PDCCH detection provided in an embodiment of the present disclosure. As an example, the method is applied to the terminal device 100 in FIG. 1. As illustrated in FIG. 2, the method for PDCCH detection includes the following operation.

At operation S200, a terminal device performs blind detection based on a PDCCH configuration sent by a network device, to obtain target DCI.

The PDCCH configuration corresponds to a target carrier combination group.

A group of carrier combinations is a group composed of one or more carrier combinations, each carrier combination is composed of one or more scheduled carriers. In an embodiment of the present disclosure, the target carrier combination group may be any group of carrier combinations among all scheduled groups of carrier combinations corresponding to the terminal device. The target carrier combination group includes one or more carrier combinations, and each carrier combination includes one or more scheduled carriers.

A scheduling relationship of groups of carrier combinations in multi-carrier scheduling will be described below with reference to illustrations of figures.

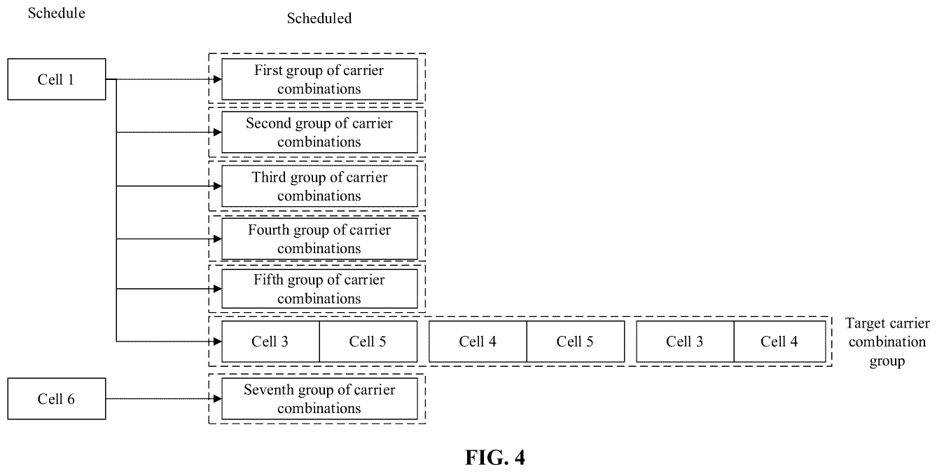

In some embodiments, it is assumed that a network device configures six carriers which are carrier 1 to carrier 6 (cell 1 to cell 6) for a terminal device through a high-level signaling. The six carriers belong to a same cell group, for example, they all belong to a master cell group (MCG), or all belong to a secondary cell group (SCG), or all belong to a primary PUCCH (cell) group. The scheduling relationship among the multiple groups of carrier combinations configured by the network device for the terminal device through the high-level signaling is illustrated in FIG. 3. A first group of carrier combinations to a sixth group of carrier combinations are scheduled by carrier 1 (cell 1 illustrated in FIG. 3), and a seventh group of carrier combinations is scheduled by carrier 6 (cell 6 illustrated in FIG. 3). Each of the first to seventh groups of carrier combinations is composed of one or more carrier combinations, and each carrier combination is composed of one or more carriers among carrier 1 to carrier 6.

The above target carrier combination group may be any group of carrier combinations among the first group of carrier combinations to the seventh group of carrier combinations illustrated in FIG. 3. Taking the target carrier combination group being the sixth group of carrier combinations illustrated in FIG. 3 as an example, with reference to FIG. 4, the target carrier combination group may include three carrier combinations: a first carrier combination including scheduled carrier 3 (cell 3 illustrated in FIG. 4) and scheduled carrier 5 (cell 5 illustrated in FIG. 4), a second carrier combination including scheduled carrier 4 (cell 4 illustrated in FIG. 4) and scheduled carrier 5 (cell 5 illustrated in FIG. 4), and a third carrier combination including the scheduled carrier 3 (cell 3 illustrated in FIG. 4) and scheduled carrier 4 (cell 4 illustrated in FIG. 4).

In an embodiment of the present disclosure, the PDCCH configuration corresponds to the target carrier combination group. Specifically, the network device configures the PDCCH configuration by taking a carrier combination group as a unit. The network device configures one PDCCH configuration for the target carrier combination group, or the network device configures multiple PDCCH configurations for the target carrier combination group, and the multiple PDCCH configurations correspond to multiple bandwidth parts (BWPs) of the target carrier combination group one by one. The network device sends one or more configured PDCCH configurations to the terminal device through a scheduling carrier corresponding to the target carrier combination group. That is, the terminal device receives the PDCCH configuration for the target carrier combination group from the network device before the terminal device performs blind detection based on the PDCCH in configuration sent by the network device to obtain the target DCI.

In the following embodiments, taking the network device configuring one PDCCH configuration for the target carrier combination group as an example for illustration, it can be understood that the embodiments are also applicable to multiple PDCCH configurations.

Also with reference to FIG. 3, the network device may configure a first PDCCH configuration for the first group of carrier combinations, a second PDCCH configuration for the second group of carrier combinations, a third PDCCH configuration for the third group of carrier combinations, a fourth PDCCH configuration for the fourth group of carrier combinations, a fifth PDCCH configuration for the fifth group of carrier combinations, a sixth PDCCH configuration for the sixth group of carrier combinations, and a seventh PDCCH configuration for the seventh group of carrier combinations.

The contents of PDCCH configuration are introduced below.

In an embodiment of the present disclosure, the PDCCH configuration may be PDCCH-Config or other parameters related to PDCCH configuration, such as PDCCH-ServingCellConfig (i.e., PDCCH service cell configuration), which are not specifically limited herein. The contents of the PDCCH configuration, when the PDCCH configuration is PDCCH-Config, are described below.

A series of specific parameters needed by the terminal device to receive user-specific control information and group-common control information are configured in the PDCCH-Config. PDCCH-Config is configured independently for each BWP of each serving cell. This parameter includes a control-resource set (CORESET) configuration, a search space (SearchSpace) configuration, a group-common control information configuration and so on.

SearchSpace configures a way of how the terminal device detects DCI on certain time-frequency resources. This parameter is configured independently for each BWP of each serving cell, and up to 10 SearchSpaces may be configured for each BWP of each serving cell. Each SearchSpace is associated with a CORESET. Parameters of SearchSpace include: a SearchSpace Identity (ID), a CORESET ID associated with the SearchSpace, a period offset, a length of SearchSpace in a period, a detection symbol in a slot, an aggregation level to be detected, a size of candidate set corresponding to each aggregation level to be detected, a type of SearchSpace, and a DCI format corresponding to each type of SearchSpace.

The CORESET configures a frequency domain position of each PDCCH detection region, a time domain resource length, and a resource mapping structure in the detection region. Parameters of CORESET include: a frequency domain resource position, a time domain resource length, a resource mapping mode (whether interleaved or not), a precoding granularity, a transmission configuration index (TCI) configuration, a demodulation reference signal (DMRS) scrambling code ID, etc. These parameters are configured independently for each BWP of each serving cell, and up to 3 CORESETs may be configured for each BWP of each serving cell.

For a group of carrier combinations such as the target carrier combination group, all carrier combinations in the target carrier combination group share a PDCCH configuration configured for the target carrier combination group. The terminal device performs blind detection on a PDCCH based on the SearchSpace configuration and the CORESET configuration in the PDCCH configuration sent by the network device, to obtain target DCI. The target DCI is used for scheduling a carrier combination in the target carrier combination group, that is, the resource indicated by the target DCI is in the carrier combination of the target carrier combination group.

According to the above embodiments, the terminal device performs the blind detection based on the PDCCH configuration sent by the network device, to obtain the target DCI. The PDCCH configuration corresponds to the target carrier combination group, the target carrier combination group includes one or more carrier combinations, each carrier combination includes one or more carriers, and the target DCI is for scheduling a carrier combination in the target carrier combination group. In such way, the target carrier combination group is configured with a corresponding PDCCH configuration, and the terminal device may perform the blind detection based on the PDCCH configuration of the target carrier combination group, to obtain the target DCI for the terminal device. Therefore, identification and acquisition of the DCI for the terminal device can be achieved.

It should be noted that the method provided by the embodiments of the present disclosure may also be used by combining various embodiments. As an example, a manner of distributing resources scheduled by target DCI on multiple carriers may be combined with a manner of limiting resources scheduled by another DCI to one carrier.

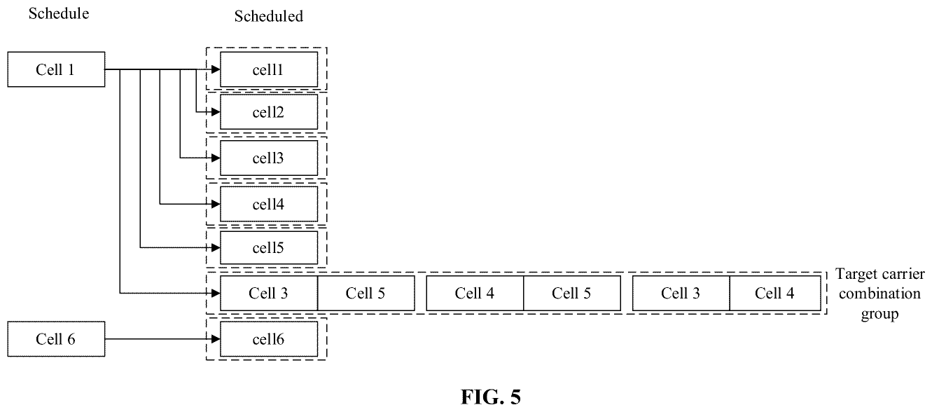

In some embodiments, with reference to FIG. 5, similar to the above assumption, it is assumed that a network device configures six carriers which are carrier 1 to carrier 6 (i.e., cell 1 to cell 6) for a terminal device through high-level signaling, and the network device configures a scheduling relationship among multiple carriers for the terminal device through the high-level signaling. As shown in FIG. 5, carrier 1 separately schedules carrier 1 to carrier 5, and carrier 1 also schedules a target carrier combination group composed of three carrier combinations, and carrier 6 separately schedules carrier 6.

The network device, when configuring a PDCCH, may consider each of separately scheduled carrier 1 to carrier 6 as a respective carrier combination group, and may configure a first PDCCH configuration for the scheduled carrier 1, a second PDCCH configuration for the scheduled carrier 2, a third PDCCH configuration for the scheduled carrier 3, a fourth PDCCH configuration for the scheduled carrier 4, a fifth PDCCH configuration for the scheduled carrier 5, a sixth PDCCH configuration for the scheduled target carrier combination group, and a seventh PDCCH configuration for the scheduled carrier 6, and send each of the configured PDCCH configurations to the terminal device through a corresponding scheduling carrier (i.e., carrier 1 and carrier 6).

The terminal device, after receiving various PDCCH configurations, may perform blind detection on the PDCCH based on the first PDCCH configuration to obtain a DCI used for scheduling carrier 1, perform blind detection on the PDCCH based on the second PDCCH configuration to obtain a DCI used for scheduling carrier 2 . . . , perform blind detection on the PDCCH based on the sixth PDCCH configuration to obtain a DCI used for scheduling a carrier combination in the target carrier combination group, and perform blind detection on the PDCCH based on the seventh PDCCH configuration to obtain a DCI used for scheduling carrier 6. In this way, the combined use of a DCI scheduling one carrier and a DCI scheduling multiple carriers can be realized, and utility of the embodiments of the disclosure can be improved.

Division manners for the target carrier combination group will be introduced in the following.

In an embodiment of the disclosure, the target carrier combination group may be configured by the network device to the terminal device through a high-level signaling. Alternatively, the target carrier combination group may be determined by the terminal device based on a preset combination rule which may be specified by a communication protocol.

In some embodiments, the terminal device may determine, by receiving the high-level signaling, carrier combinations which are included in the target carrier combination group and scheduled carriers which are included in each carrier combination.

In some embodiments, the preset combination rule may be, for example, that a group of scheduled carrier combinations consists of any combination of scheduled carriers including the same scheduled carrier. For example, also with reference to FIG. 5, it is assumed that the scheduled carrier is carrier 5, then the carrier combinations including carrier 5 are: a carrier combination composed of carrier 3 and carrier 5, and a carrier combination composed of carrier 4 and carrier 5. Thus, the terminal device determines that the target carrier combination group includes these two carrier combinations. Further, after carrier 3 and carrier 4 are introduced, the terminal device also needs to incorporate the carrier combination including carrier 3 and carrier 4 into the target carrier combination group, thereby incorporating the carrier combination composed of carrier 3 and carrier 4 into the target carrier combination group. Finally, it is determined that the target carrier combination group includes the carrier combination composed of carrier 3 and carrier 5, the carrier combination composed of carrier 4 and carrier 5, and the carrier combination composed of carrier 3 and carrier 4. Part or all of the frequency domain resources on one carrier combination in the target carrier combination group may be scheduled by one PDCCH.

In some embodiments, the preset combination rule may also specify a total number of carriers in a group of carrier combinations, or specify a total number of carrier combinations in a group of carrier combinations and a number of carriers in each carrier combination, etc. Thus, the base station device may divide groups of carrier combinations based on the limitation of the number of carriers and the number of carrier combinations.

Of course, in other possible embodiments, the target carrier combination group may also be determined by the terminal device based on both the high-level signaling and the preset combination rule specified by the communication protocol, and the division manner of the target carrier combination group is not specifically limited herein.

In this way, the terminal device may divide the target carrier combination group in various ways. Therefore, flexibility of network configuration can be increased, and the configuration can be carried out according to an actual scheduling situation in practice, which is beneficial to balancing the capability division of PDCCH and improving the transmission efficiency of PDCCH.

In some embodiments, in case that a carrier combination includes multiple carriers, each carrier in the carrier combination may have a same sub-carrier spacing, and/or each carrier in the carrier combination may be configured with a same PUCCH group.

On one hand, since the carrier combination is scheduled as a whole, if the sub-carrier spacings (SCSs) of various carriers in the carrier combination are different, it is necessary to add an additional indication field in the target DCI to distinguish the various carriers, which may lead to excessive overhead of the target DCI.

In some embodiments, a time domain resource assignment (TDRA) field in the DCI is used for indicating a time domain resource. If various carriers in a carrier combination, in the target carrier combination group, scheduled by the target DCI have the same sub-carrier spacing, then three symbols indicated by the TDRA field in the target DCI are three symbols on each carrier in the carrier combination. However, if various carriers in the carrier combination do not have same sub-carrier spacing, for example, a length of three symbols of carrier 1 is equal to a length of six symbols of carrier 2 in the carrier combination. Then, if the TDRA field of the target DCI indicates three symbols, it is necessary to add other indication information to the target DCI to distinguish the specific corresponding lengths of the three symbols on various carriers in the carrier combination, which may lead to redundancy of the target DCI.

According to the embodiment of the disclosure, the TDRA field in the target DCI can be efficiently shared by configuring various carriers in a carrier combination with same sub-carrier spacing, so that the target DCI can be designed more efficiently.

On the other hand, various carriers in a carrier combination are configured to have a same PUCCH group, thus the PUCCH resource fields of the various carrier are also the same, that is, the PUCCH resource field can be shared by the carrier combination, thus realizing effective sharing of the PUCCH resource field.

The terminal device, after obtaining the target DCI by performing blind detection on the PDCCH based on the PDCCH configuration configured by the network device for the target carrier combination group, needs to determine, through a cross-carrier configuration configured by the network device, an association relationship between a scheduling carrier (cell 1 as shown in FIG. 4) and a scheduled group of carrier combinations (the target carrier combination group as shown in FIG. 4) or between the scheduling carrier and a carrier combination in the scheduled group of carrier combinations. Therefore, the terminal device can finally determine a resource position indicated by the target DCI.

The cross-carrier configuration involved in the embodiments of the present disclosure will be described in the following.

In an embodiment of the present disclosure, the network device may also configure carrier indication information in the target DCI. The terminal device performs blind detection on a PDCCH according to a PDCCH configuration configured for a target carrier combination group to obtain target DCI. The target DCI includes carrier indication information. The carrier indication information may be configured for indicating the target carrier combination group, or the carrier indication information may be configured for indicating a target carrier combination in the target carrier combination group.

In a possible embodiment, the carrier indication information may be configured for a group of carrier combinations, in other words, one group of carrier combinations corresponds to one piece of carrier indication information.

In some embodiments, one piece of carrier indication information may be included in the target DCI for the target carrier combination group.

In some embodiments, the carrier indication information may be determined through a carrier indicator field (CIF) in the target DCI, and the target carrier combination group may be indicated by a value of the CIF. Thus, the terminal device, after obtaining the target DCI through blind detection, may determine the target carrier combination group indicated by the target DCI according to the CIF value in the carrier indication information in the target DCI.

In some embodiments, the carrier indication information may include multiple CIFs which are used for jointly indicating a target carrier combination in the target carrier combination group. For example, a value of a CIF in the multiple CIFs is used for indicating the target carrier combination group, and each of values of other CIFs is used for indicating a carrier combination (i.e., the target carrier combination), scheduled by the target DCI, in the target carrier combination group (with reference to FIG. 4, for example, the CIF value of 5 indicating the carrier combination composed of carrier 3 and carrier 5 in the target carrier combination group, the CIF value of 6 indicating the carrier combination composed of carrier 4 and carrier 5, and the CIF value of 7 indicating the carrier combination composed of carrier 3 and carrier 4). Therefore, the terminal device, after obtaining the target DCI through the blind detection, may determine the target carrier combination in the target carrier combination group indicated by the target DCI according to the multiple CIF values in the carrier indication information in the target DCI.

In some embodiments, the carrier indication information may be determined through a target indication field in the target DCI. The target indication field and the CIF are different information fields in the target DCI, i.e., the target indication field may be one or more than one information field in the target DCI other than the CIF. In a possible embodiment, the target indication field is at least one of: a frequency domain resource allocation field (i.e., FDRA), a time domain resource assignment field (i.e., TDRA), a new data information field (i.e., a new data indicator, NDI) and an HARQ process information field (i.e., HARQ process) in the target DCI.

For example, taking the frequency domain resource allocation field as an example, with reference to FIG. 4, when the frequency domain resource indicated by FDRA is only on carrier 3 and carrier 5 in the target carrier combination group, the target DCI schedules the carrier combination composed of carrier 3 and carrier 5 in the target carrier combination group. When the frequency domain resource indicated by FDRA is only on carrier 4 and carrier 5 in the target carrier combination group, the target DCI schedules the carrier combination composed of carrier 4 and carrier 5 in the target carrier combination group.

In some embodiments, the carrier indication information may be determined by a CIF and a target indication field jointly. For example, the CIF value indicates the target carrier combination group and the target indication field indicates the target carrier combination in the target carrier combination group.

In some embodiments, the carrier indication information may also be located in a dedicated information field in the target DCI, and the dedicated information field indicates a specific carrier, which is scheduled by the target DCI, in the target carrier combination group.

In a possible embodiment, the carrier indication information may be configured for a carrier combination, in other words, one group of carrier combinations corresponds to multiple pieces of carrier indication information.

In some embodiments, with regard to the target carrier combination group, there are multiple pieces of carrier indication information in the target DCI, each piece of carrier indication information corresponds to one carrier combination. The multiple pieces of carrier indication information are used for jointly indicating a target carrier combination in the target carrier combination group.

For example, also with reference to FIG. 4, first carrier indication information is configured for the carrier combination composed of carrier 3 and carrier 5, second carrier indication information is configured for the carrier combination composed of carrier 4 and carrier 5, and third carrier indication information is configured for the carrier combination composed of carrier 3 and carrier 4. The case that certain carrier indication information is assigned a first value means that the target DCI schedules the carrier combination corresponding to the carrier indication information. The case that certain carrier indication information is assigned a second value means that the target DCI does not schedule the carrier combination corresponding to the carrier indication information. The first value may be 1 or Y (abbreviation of “YES”), and the second value may be 0 or N (abbreviation of “NO”), and so on. For example, the fact that the value of the certain carrier indication information is Y means that the target DCI schedules the carrier combination corresponding to the carrier indication information, and the fact that the value of the certain carrier indication information is N means that the target DCI does not schedule the carrier combination corresponding to the carrier indication information.

In this way, the cross-carrier configuration based on a carrier combination, that is, carrier indication information being configured for a carrier combination separately, is beneficial for the terminal device to quickly distinguish carrier combinations. In addition, of carrier combination groups or carrier combinations may share the cross-carrier configuration, so that radio resource control (RRC) signaling overhead can be reduced. Moreover, the cross-carrier configuration can be carried out based on carrier combination groups or carrier combinations, thus improving the configuration flexibility.

In addition, in the method provided by the embodiments of the present disclosure, various implementations may also be used in combination. For example, combination of a manner of distributing resources scheduled by the target DCI on multiple carriers and a manner of limiting resources scheduled by another DCI to one carrier is described. With reference to FIG. 5, the network device considers each of separately scheduled carrier 1 to carrier 6 as a respective group of carrier combinations. Specifically, the network device may configure first carrier indication information in the DCI corresponding to the scheduled carrier 1 . . . , configure sixth carrier indication information in the target DCI corresponding to the scheduled target carrier combination group, configure seventh carrier indication information in the DCI corresponding to the scheduled carrier 6. A CIF is configured respectively in each of the first carrier indication information to the fifth carrier indication information and the seventh carrier indication information, to indicate a corresponding carrier; and a CIF is configured in the sixth carrier indication information to indicate the target carrier combination group or multiple CIFs are configured to indicate a target carrier combination in the target carrier combination group. Therefore, the utility of the embodiments of the disclosure can be improved.

The terminal device, before obtaining the target DCI through blind detection on the PDCCH based on the PDCCH configuration for the target carrier combination group according to the above embodiments, also needs to perform DCI format alignment processing because the terminal device does not know information such as the format of the target DCI before blind detection on the PDCCH. Therefore, the terminal device needs to use some fixed DCI sizes to perform blind detection based on the PDCCH configuration for the target carrier combination group configuration.

In order to reduce complexity of blind detection by the terminal device, the traditional technology usually restricts the number of DCI sizes on each scheduled carrier. For example, when the terminal device is configured with more than three DCI formats scrambled by a cell-radio network temporary identity (C-RNTI), the DCI size of each DCI format is different from another one, and the number of DCI sizes is maintained at 3 by aligning DCI sizes. Therefore, the terminal device only needs to perform blind detection for three DCI sizes rather than for each DCI format, and the terminal device, after detecting the DCI, may distinguish different DCI formats of the same DCI size by reading the contents in the DCI. At present, it is specified by the protocol that for each scheduled carrier that, the number of DCI sizes is not greater than 4, and the number of DCI sizes scrambled by C-RNTI is not greater than 3.

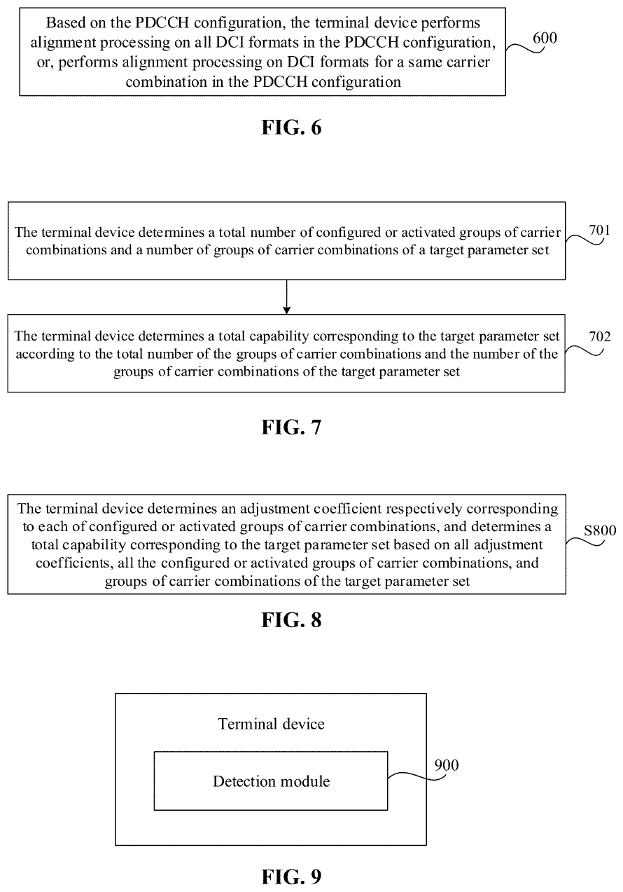

The procedure of DCI format alignment by the terminal device in an embodiment of the present disclosure is described below. Based on the embodiment shown in FIG. 2 and with reference to FIG. 6, in this embodiment, the method for PDCCH detection may further include an operation 600.

At operation 600, based on the PDCCH configuration, the terminal device performs alignment processing on all DCI formats in the PDCCH configuration, or, performs alignment processing on DCI formats for a same carrier combination in the PDCCH configuration.

In some embodiments, the PDCCH configuration may include all DCI formats corresponding to the target carrier combination group, and the terminal device may perform alignment on all DCI formats for the target carrier combination group in the PDCCH configuration.

For example, the network device configures DCI format 0_0, DCI format 0_1 and DCI format 0_2 for uplink scheduling of the target carrier combination group, and also configures DCI format 1_0, DCI format 1_1 and DCI format 1_2 for downlink scheduling of the target carrier combination group. The DCI sizes of the DCI formats are different from each other, and the total number of DCI sizes exceeds the limitation of the total number of DCI sizes corresponding to the target carrier combination group (which is assumed as 3 in the followings). The terminal device performs alignment processing on DCI format 0_0, DCI format 0_1, DCI format 0_2, DCI format 1_0, DCI format 1_1 and DCI format 1_2, so that the number of DCI sizes is not more than 3.

In some embodiments, the PDCCH configuration may include all DCI formats corresponding to various carrier combinations in the target carrier combination group, and the terminal device may perform, based on the PDCCH configuration, alignment processing on DCI formats for all the carrier combinations in the PDCCH configuration.

For example, with reference to FIG. 4 or FIG. 5, for carrier combinations in the target carrier combination group: carrier 3 and carrier 5, carrier 4 and carrier 5, carrier 3 and carrier 4, the network device configures that each of these carrier combinations adopts same DCI formats: DCI format 0_x and DCI format 1_x, where x is a non-negative number, and that the DCI sizes of different carrier combinations are the same. Then, there are only two DCI sizes for all carrier combinations, and the total number of the DCI sizes of the three carrier combinations does not exceed the limitation of the total number of DCI sizes (i.e., 3) corresponding to the target carrier combination group. Therefore, the terminal device does not need to perform DCI size alignment.

For example, also with reference to FIG. 4 or FIG. 5, for carrier combinations in the target carrier combination group: carrier 3 and carrier 5, carrier 4 and carrier 5, carrier 3 and carrier 4, the network device configures that each carrier combination adopts same DCI formats: DCI format 0_x and DCI format 1_x, where x is a non-negative number. However, since bandwidths of carriers 3 to carrier 5 are different, the DCI sizes of different carrier combinations are also different. Then the total number of the DCI sizes of the three carrier combinations exceeds the limitation of the total number of DCI sizes (i.e., 3) corresponding to the target carrier combination group. Therefore, the terminal device needs to perform alignment on uplink and downlink DCI formats for a same carrier combination, such that the total number of DCI sizes is not more than 3.

Table 1 is illustrated as follows:

TABLE 1

| | | | Aligned |
|---|---|---|---|
| Carrier combination | DCI format | DCI size | DCI size |
| Carrier 3 and carrier 5 | DCI format 0_x, DCI | A, B | G |
| | format 1_x | | |
| Carrier 4 and carrier 5 | DCI format 0_x, DCI | C, D | H |
| | format 1_x | | |
| Carrier 3 and carrier 4 | DCI format 0_x, DCI | E, F | I |
| | format 1_x | | |

The terminal device aligns the uplink and downlink DCI formats of the carrier combination including the carrier 3 and the carrier 5 to obtain a DCI size G, aligns the uplink and downlink DCI formats of the carrier combination including the carrier 4 and the carrier 5 to obtain a DCI size H, and aligns the uplink and downlink DCI formats of the carrier combination including the carrier 3 and the carrier 4 to obtain a DCI size I. Therefore, the total number of the DCI sizes of the three carrier combinations is equal to the limitation of the total number of the DCI sizes corresponding to the target carrier combination group, i.e., 3.

For example, also with reference to FIG. 4 or FIG. 5, for carrier combinations in the target carrier combination group: carrier 3 and carrier 5, carrier 4 and carrier 5, carrier 3 and carrier 4, the network device configures that each carrier combination adopts same DCI formats: DCI format 0_x and DCI format 1_x, where x is a non-negative number, and that part of the DCI sizes are the same and part of the DCI sizes are different. As shown in Table 2:

TABLE 2

| | | | Aligned |
|---|---|---|---|
| Carrier combination | DCI format | DCI size | DCI size |
| Carrier 3 and carrier 5 | DCI format 0_x, DCI | A, B | E |
| | format 1_x | | |
| Carrier 4 and carrier 5 | DCI format 0_x, DCI | A, B | E |
| | format 1_x | | |
| Carrier 3 and carrier 4 | DCI format 0_x, DCI | C, D | C, D |
| | format 1_x | | |

The total number of the DCI sizes of the three carrier combinations exceeds the limitation of total number of DCI sizes corresponding to the target carrier combination group, i.e., 3, thus the terminal device needs to align the uplink and downlink DCI formats of the same combination.

In some embodiments, the terminal device may first align the uplink and downlink DCI formats of the carrier combinations including the carrier 3 and the carrier 5, to obtain a DCI size E, and if the total number of the DCI sizes of the three carrier combinations still exceeds 3 after this size alignment, the terminal device may continue to align the uplink and downlink DCI formats of the carrier combinations including the carrier 4 and the carrier 5, to obtain the DCI size E. Then the total number of the DCI sizes of the three carrier combinations is equal to 3 (DCI sizes are E, C and D respectively), and the terminal device finishes the DCI alignment processing.

For example, during the DCI alignment process of the carrier combinations, the terminal device may firstly perform the alignment operation on the uplink and downlink DCI formats of the carrier combination with smaller DCI sizes than that of other carrier combinations. Therefore, after the alignment operation on the uplink and downlink DCI formats of the carrier combination with smaller DCI sizes is performed preferentially, if the total number of DCI sizes corresponding to the target carrier combination group meets the limitation, the subsequent alignment does not need to be performed. In such way, the alignment speed can be improved because the difference of the uplink and downlink DCI sizes is also small under the condition that DCI sizes are small.

In the above embodiments, DCI formats in the target carrier combination group or DCI formats in a carrier combination are aligned, so that alignment of DCI sizes between different groups of carrier combinations or between the target carrier combination group and other separately scheduled carriers can be avoided, and over-redundancy of the DCI information field can be also avoided.

It should be noted that the method provided by the embodiments of the present disclosure may also be used by combining various embodiments. For example, combination of a manner of distributing resources scheduled by the target DCI on multiple carriers and a manner of limiting the resources scheduled by another DCI to one carrier is described. With reference to FIG. 5, in a possible embodiment, the terminal device may consider each of separately scheduled carrier 1 to carrier 6 as a group of carrier combinations, and then align multiple DCI formats in each group of carrier combinations when performing the DCI format alignment.

In some embodiments, a terminal device may perform the alignment operation of DCI format sizes on multiple DCI formats for scheduling the carrier 1, perform the alignment operation of DCI format sizes on multiple DCI formats for scheduling the carrier 2, . . . , perform the alignment operation of DCI format sizes on multiple DCI formats for scheduling the target carrier combination group, and perform the alignment operation of DCI format sizes on multiple DCI formats for scheduling the carrier 6.

In another possible embodiment, when the terminal device performs alignment processing on the DCI formats, the terminal device may give priority to aligning the “one-scheduling-one” DCI formats. “One-scheduling-one” is a mode that resources scheduled by one DCI are limited to one carrier. The above target type of DCI is the “one-scheduling-one” DCI.

The alignment processing in the embodiment illustrated in FIG. 6 may include that the terminal device performs the alignment processing based on a preset alignment processing condition. The alignment processing condition is that the number of all DCI formats with different sizes within the current alignment processing range is greater than a number threshold, and there is no unaligned target type of DCI within the current alignment processing range, the target type of DCI herein is used for scheduling one carrier.

Also with reference to FIG. 5, the network device configures carrier 1 to carrier 6 for the terminal device through the high-level signaling. The carrier 1 is for scheduling carrier 1 to carrier 5 separately, and the carrier 1 is also for scheduling the target carrier combination group composed of three carrier combinations. The carrier 6 is for scheduling carrier 6. The terminal device, after receiving the PDCCH configuration of each scheduled unit (individual carrier 1 to carrier 6 or the target carrier combination group), first aligns the DCI formats corresponding to the separately scheduled carrier 1 to carrier 6 if the total number of sizes of DCI formats in all PDCCH configurations is greater than the limitation of the total number of DCI sizes in the current whole scheduling process. The terminal device will finally align the DCI formats of the target carrier combination group if the total number of the sizes of the DCI formats obtained after aligning the DCI formats corresponding to carriers 1 to 6 is still greater than the limitation of the total number of DCI sizes in the current whole scheduling process.

In this way, since the size of the “one-scheduling-one” DCI format is usually small and is smaller than the size of the DCI format of the target carrier combination group, and an absolute difference between the DCI formats with small DCI sizes is also small, therefore, redundant bits brought by the alignment operation can be reduced and the alignment speed can be improved by preferentially aligning the DCIs with small DCI sizes.

In the process that the terminal device performs blind detection based on the PDCCH configuration configured for the target carrier combination group according to the above embodiments, the terminal device also needs to determine a PDCCH detection capability of the terminal device, and constrains the number of blind detections according to the determined PDCCH detection capability, so as to ensure that the number of detections corresponding to the PDCCH configuration configured by the network device is within a realization capability range of the terminal device. When the blind detection or channel estimation required for the PDCCH detection configured by the network device exceeds the PDCCH detection capability of the terminal device, the terminal device stops continuing detection of DCI on the remaining potential resources.

The procedure of determination of the PDCCH detection capability by the terminal device in an embodiment of the present disclosure is described below.

In an embodiment of the present disclosure, in the process of blind detection, the terminal device also needs to determine the PDCCH detection capability corresponding to the target carrier combination group.

For a multi-carrier system, since the PDCCH detection capability of the terminal device may not increase linearly with the increase of the number of carriers, the total capability of PDCCH detection of the terminal device under multi-carrier situation is constrained by constraining the maximum number of carriers of the PDCCH detection.

Specifically, for each scheduled carrier, the maximum number of blind detections of PDCCH is min(M_{PDCCH}^{max,slot,μ}, M_{PDCCH}^{total,slot,μ}), and the maximum number of non-overlapped control channel elements (CCEs) for blind channel estimation is min(C_{PDCCH}^{max,slot,μ}, C_{PDCCH}^{total,slot,μ}), where values of M_{PDCCH}^{max,slot,μ} and C_{PDCCH}^{max,slot,μ} are shown in Tables 3 and 4:

TABLE 3

| μ | M_{PDCCH}^{max, slot, μ} |
|---|---|
| 0 | 44 |
| 1 | 36 |
| 2 | 22 |
| 3 | 20 |

TABLE 4

| μ | C_{PDCCH}^{max, slot, μ} |
|---|---|
| 0 | 56 |
| 1 | 56 |
| 2 | 48 |
| 3 | 32 |

where μ is an identification field of sub-carrier spacing, and different μ represents different sub-carrier spacings for scheduling carriers.

M_{PDCCH}^{total,slot,μ} and C_{PDCCH}^{total,slot,μ} are calculated as shown in following Formula 1 and Formula 2:

$${M}_{PDCCH}^{total , slot , μ} = [ {N}_{cells}^{cap} \cdot {M}_{PDCCH}^{max , slot , μ} \cdot {N}_{cells}^{DL , μ} / {\sum }_{j = 0}^{3} {N}_{cells}^{DL , j} ] \qquad Formula 1$$

$${C}_{PDCCH}^{total , slot , μ} = [ {N}_{cells}^{cap} \cdot {C}_{PDCCH}^{max , slot , μ} \cdot {N}_{cells}^{DL , μ} / {\sum }_{j = 0}^{3} {N}_{cells}^{DL , j} ] \qquad Formula 2$$

where N_{cells}^{cap} is the maximum number of carriers of PDCCH detection reported by the terminal terminal, N_{cells}^{DL,μ} is a total capability corresponding to μ, and its value is associated with the number of scheduled carriers corresponding to the scheduling carrier with a sub-carrier spacing of μ, and N_{cells}^{DL,j} is the number of carriers with a numerology (i.e., a sub-carrier spacing type) of j, and the value of Σⱼ₌₀³N_{cells}^{DL,j} is associated with the number of all the configured carriers.

In an embodiment of the present disclosure, the PDCCH detection capability includes a maximum number of candidate PDCCHs monitored by the terminal device and/or a maximum number of non-overlapped CCEs for channel estimation. Taking the PDCCH detection capability including the maximum number of candidate PDCCHs monitored by the terminal device and the maximum number of non-overlapped CCEs for channel estimation as an example in the following.

The “maximum number of monitored candidate PDCCHs” is equivalent to the “maximum number of blind detections of PDCCH” described herein, and the “maximum number of non-overlapped CCEs for channel estimation” is equivalent to the “maximum number of non-overlapped CCEs for blind channel estimation” described herein.

On the above-mentioned basis, the maximum number of blind detections of PDCCH by the terminal device is min(M_{PDCCH}^{max,slot,μ}, M_{PDCCH}^{total,slot,μ}), and the maximum number of non-overlapped CCEs for blind channel estimation is min(C_{PDCCH}^{max,slot,μ}, C_{PDCCH}^{total,slot,μ}). That is, in the embodiment of the present disclosure, the PDCCH detection capability is a minimum min(M_{PDCCH}^{max,slot,μ}, M_{PDCCH}^{total,slot,μ}) and min(C_{PDCCH}^{max,slot,μ}, C_{PDCCH}^{total,slot,μ}) between the maximum capability corresponding to the target carrier combination group (M_{PDCCH}^{max,slot,μ} and C_{PDCCH}^{max,slot,μ}) and the total capability (M_{PDCCH}^{total,slot,μ} C_{PDCCH}^{total,slot,μ}) corresponding to the target parameter set. The target parameter set is a parameter set of the scheduling carrier corresponding to the target carrier combination group, and the parameter set includes the sub-carrier spacing value μ.

The maximum capability corresponding to the target carrier combination group may be obtained from Table 3 and Table 4, and a manner for determining the total capability corresponding to the target parameter set will be described below.

In a possible embodiment, with reference to FIG. 7, the terminal device may perform operations 701 and 702 illustrated in FIG. 7 to implement the process of determining the total capability corresponding to the target parameter set.

At operation 701, the terminal device determines a total number of configured or activated groups of carrier combinations and a number of groups of carrier combinations of the target parameter set.

As described above, the target parameter set is a parameter set of the scheduling carrier corresponding to the target carrier combination group.

The configured groups of carrier combinations may include all the groups of carrier combinations configured by the network device to the terminal device, the activated groups of carrier combinations may include activated and available groups of carrier combinations among all the groups of carrier combinations configured by the network device to the terminal device, and the groups of carrier combinations of the target parameter set may include all the groups of carrier combinations corresponding to the u value of the scheduling carrier corresponding to the target carrier combination group.

With reference to FIG. 3, all the groups of carrier combinations configured by the network device to the terminal device are the first group of carrier combinations to the seventh group of carrier combinations, totally 7 groups of carrier combinations, then the total number of the configured groups of carrier combinations is 7. If all the 7 groups of carrier combinations are activated, the total number of the activated groups of carrier combinations is also 7. It can be understood that the total number of the activated groups of carrier combinations is less than or equal to the total number of the configured groups of carrier combinations.

Further with reference to FIG. 3, it is assumed that carrier 1 (cell 1) is configured with μ=0 and carrier 6 (cell 6) is configured with μ=1, then μ=0 corresponds to the number of groups of carrier combinations of 6, and μ=1 corresponds to the number of groups of carrier combinations of 1.

At operation 702, the terminal device determines the total capability corresponding to the target parameter set according to the total number of the groups of carrier combinations and the number of the groups of carrier combinations of the target parameter set.

The terminal device substitutes the total number of the groups of carrier combinations and the number of the groups of carrier combinations of the target parameter set in the Formula 1 and Formula 2, to obtain the total capability corresponding to the target parameter set M_{PDCCH}^{total,slot,μ} and C_{PDCCH}^{total,slot,μ}.

In some embodiments, further with reference to FIG. 3, it is assumed that the target carrier combination group is the sixth group of carrier combinations, carrier 1 corresponds to μ=0, carrier 6 corresponds to μ=1, and values of M_{PDCCH}^{max,slot,μ} and C_{PDCCH}^{max,slot,μ} are shown in Tables 3 and 4.

Further, it is assumed that the maximum number of carriers of PDCCH detection reported by the terminal device to the network device is N_{cells}^{cap}=2, further with reference to FIG. 3, in the embodiment of the present disclosure, the traditional count of scheduled carriers is replaced by the count of groups of carrier combinations, so that the total number of configured groups of carrier combinations is 7, the number of groups of carrier combinations corresponding to μ=0 (corresponding to scheduling carrier 1) is 6, and the number of groups of carrier combinations corresponding to μ=1 (corresponding to scheduling carrier 6) is 1.

Then, for the first group of carrier combinations to the sixth group of carrier combinations (i.e., the target carrier combination group): substitute N_{cells}^{cap}=2, N_{cells}^{DL,μ}=6, Σⱼ₌₀³N_{cells}^{DL,j}7 in Formula 1 and Formula 2, to obtain M_{PDCCH}^{total,slot,μ} and C_{PDCCH}^{total,slot,μ} as follows:

$$\begin{matrix}{M}_{PDCCH}^{total , slot , μ} = [ 2 \cdot {M}_{PDCCH}^{max , slot , μ} \cdot 6 / 7 ] \\ {C}_{PDCCH}^{total , slot , μ} = [ 2 \cdot {C}_{PDCCH}^{max , slot , μ} \cdot 6 / 7 ]\end{matrix}$$

The terminal device obtains the maximum capability M_{PDCCH}^{max,slot,μ} and C_{PDCCH}^{max,slot,μ} corresponding to the target carrier combination group based on Table 3 and Table 4, and obtains the PDCCH detection capability by taking the minimum between the maximum capability corresponding to the target carrier combination group and the total capability corresponding to the target parameter set. It should be noted that the terminal device calculates the PDCCH detection capability for each μ. Therefore, in case that the scheduling carrier corresponding to the target carrier combination group simultaneously schedules multiple groups of carrier combinations, the multiple groups of carrier combinations share the PDCCH detection capability corresponding to μ, so that the terminal device obtains the PDCCH detection capability, corresponding to the target carrier combination group, shared by the target carrier combination group and other groups of carrier combinations.

It is assumed that the target carrier combination group is the seventh group of carrier combinations, the remaining assumptions are the same as that of the above-mentioned embodiments. Similarly, the maximum number of PDCCH blind detections of the terminal device is min(M_{PDCCH}^{max,slot,μ}, M_{PDCCH}^{total,slot,μ}), the maximum number of non-overlapped CCEs for blind channel estimation is min(C_{PDCCH}^{max,slot,μ}, C_{PDCCH}^{total,slot,μ}), and the values of M_{PDCCH}^{max,slot,μ} and C_{PDCCH}^{max,slot,μ} are shown in Table 3 and Table 4.

Then, for the seventh group of carrier combinations (i.e., the target carrier combination group): substitute N_{cells}^{cap}=2, N_{cells}^{DL,μ}=1, Σⱼ₌₀³N_{cells}^{DL,j}=7 in Formula 1 and Formula 2, to obtain M_{PDCCH}^{total,slot,μ} and C_{PDCCH}^{total,slot,μ} as follows:

$$\begin{matrix}{M}_{PDCCH}^{total , slot , μ} = [ 2 \cdot {M}_{PDCCH}^{max , slot , μ} \cdot 1 / 7 ] \\ {C}_{PDCCH}^{total , slot , μ} = [ 2 \cdot {C}_{PDCCH}^{max , slot , μ} \cdot 1 / 7 ]\end{matrix}$$

Thus, the PDCCH detection capability of the seventh group of carrier combinations (i.e., the target carrier combination group) may be obtained by taking the minimum of the maximum capability corresponding to the target carrier combination group and the total capability corresponding to the target parameter set. Since the carrier 6 only schedules the target carrier combination group, the PDCCH detection capability calculated for the carrier 6 is exclusively owned by the target carrier combination group, so that the terminal device obtains a separate PDCCH detection capability corresponding to the target carrier combination group.

In a possible embodiment, with reference to FIG. 8, the terminal device may perform operation S800 illustrated in FIG. 8 to implement the process of determining the total capability corresponding to the target parameter set.

At operation S800, the terminal device determines an adjustment coefficient respectively corresponding to each of configured or activated groups of carrier combinations, and determines a total capability corresponding to the target parameter set based on all adjustment coefficients, all the configured or activated groups of carrier combinations, and groups of carrier combinations of the target parameter set.

On the basis of the above-mentioned implementations, when performing the capability division for multiple groups of carrier combinations in this implementation, an adjustment coefficient may be introduced to each group of carrier combinations, and the adjustment coefficient may be agreed in a protocol or configured by a high-level signaling.

In an operation of counting the scheduled groups of carrier combinations, each group of carrier combinations may be multiplied by an adjustment coefficient which is non-negative, and the adjustment coefficient may be determined, according to the number of carrier combinations corresponding to each group of carrier combinations, in a manner agreed by the protocol.

Also with reference to FIG. 3, it is assumed that the total capability corresponding to the target parameter set is calculated based on the total number of configured groups of carrier combinations, and the adjustment coefficients of the first group of carrier combinations to the sixth group of carrier combinations are {1, 1, 0.7, 0.7, 0.7, 0.9}, respectively, and the adjustment coefficient of the seventh group of carrier combinations is 1. Other assumptions are similar to the examples of the embodiments of the above operation 702, then for the first group of carrier combinations to the sixth group of carrier combinations, the values of M_{PDCCH}^{max,slot,μ} and C_{PDCCH}^{max,slot,μ} are also shown in Table 3 and Table 4, and the values of M_{PDCCH}^{total,slot,μ} and C_{PDCCH}^{total,slot,μ} are as follows:

$${M}_{PDCCH}^{total , slot , μ} = [ 2 \cdot {M}_{PDCCH}^{max , slot , μ} \cdot ( 1 + 1 + 0.7 + 0.7 + 0.7 + 0.9 ) / ( 1 + 1 + 0.7 + 0.7 + 0.7 + 0.9 + 1 ) ]$$

$${C}_{PDCCH}^{total , slot , μ} = [ 2 \cdot {C}_{PDCCH}^{max , slot , μ} \cdot ( 1 + 1 + 0.7 + 0.7 + 0.7 + 0.9 ) / ( 1 + 1 + 0.7 + 0.7 + 0.7 + 0.9 + 1 ) ]$$

Therefore, the PDCCH detection capability of the first group of carrier combinations to the sixth group of carrier combinations can be obtained by taking the minimum between the maximum capability corresponding to the target carrier combination group and the total capability corresponding to the target parameter set. Similar to the above embodiment, if the target carrier combination group is a group of carrier combinations among the first group of carrier combinations to the sixth group of carrier combinations, for example, the sixth group of carrier combinations, in case that the scheduling carrier corresponding to the target carrier combination group simultaneously schedules multiple groups of carrier combinations, the multiple groups of carrier combinations may share the PDCCH detection capability corresponding to μ, so that the terminal device obtains the PDCCH detection capability, corresponding to the target carrier combination group, shared by the target carrier combination group and other groups of carrier combinations.

It is assumed that the target carrier combination group is the seventh group of carrier combinations, the remaining assumptions are the same as the above-mentioned embodiments. Similarly, the maximum number of PDCCH blind detections of the terminal device is min (M_{PDCCH}^{max,slot,μ}, M_{PDCCH}^{total,slot,μ}), the maximum number of non-overlapped CCEs for blind channel estimation is min(C_{PDCCH}^{max,slot,μ}, C_{PDCCH}^{total,slot,μ}), and the values of M_{PDCCH}^{max,slot,μ} and C_{PDCCH}^{max,slot,μ} are shown in Table 3 and Table 4. Then, for the seventh group of carrier combinations (i.e., the target carrier combination group), M_{PDCCH}^{total,slot,μ} and C_{PDCCH}^{total,slot,μ} are obtained as below:

$${M}_{PDCCH}^{total , slot , μ} = [ 2 \cdot {M}_{PDCCH}^{max , slot , μ} 1 / ( 1 + 1 + 0.7 + 0.7 + 0.7 + 0.9 + 1 ) ]$$

$${C}_{PDCCH}^{total , slot , μ} = [ 2 \cdot {C}_{PDCCH}^{max , slot , μ} 1 / ( 1 + 1 + 0.7 + 0.7 + 0.7 + 0.9 + 1 ) ]$$

Thus, the PDCCH detection capability of the seventh group of carrier combinations (i.e., the target carrier combination group) may be obtained by taking the minimum of the maximum capability corresponding to the target carrier combination group and the total capability corresponding to the target parameter set. Since the carrier 6 only schedules the target carrier combination group, the PDCCH detection capability calculated for the carrier 6 is exclusively owned by the target carrier combination group, so that the terminal device obtains a separate PDCCH detection capability corresponding to the target carrier combination group.

It should be noted that the method provided by the embodiments of the present disclosure may also be used by combining various embodiments. For example, combination of a manner of distributing resources scheduled by the target DCI on multiple carriers and a manner of limiting the resources scheduled by another DCI to one carrier is described. A carrier separately scheduled in traditional methods may be considered as a group of carrier combinations, to achieve rapid integration with the embodiments of the present disclosure, which will not be elaborated herein again.

According to the above embodiment, PDCCH detection capability allocation can be more fit with the actual PDCCH detection configuration by introducing the adjustment coefficient. For example, with reference to FIG. 5, each of separately scheduled carrier 1 to carrier 6 is considered as a respective group of carrier combinations. Carrier 3, carrier 4 and carrier 5 are not only separately scheduled, but also are scheduled as the target carrier combination group by being combined, if all the coefficients of various groups of carrier combinations shown in FIG. 5 are 1, then detection capabilities may be repeatedly allocated for some carriers. Therefore, capability allocation can be more reasonable by adding adjustment coefficients, PDCCH detection capability allocation can be more fit with an actual PDCCH detection configuration, and the distribution rationality of PDCCH detection capability can be improved.

Finally, in the above embodiments, the serving cell and the carrier have the same concept and can be replaced with each other.

In an embodiment, a method for PDCCH detection is provided, which is applied to the network device 200 shown in FIG. 1. The method includes the following operations.

The network device sends a PDCCH configuration for a target carrier combination group to a terminal device. The PDCCH configuration corresponds to the target carrier combination group, the target carrier combination group includes one or more carrier combinations, and each carrier combination includes one or more carriers. The PDCCH configuration is configured for the terminal device to perform blind detection on the PDCCH based on the PDCCH configuration to obtain target DCI, and the target DCI is for scheduling a carrier combination in the target carrier combination group.

In an embodiment of the present disclosure, the target carrier combination group may be configured by the network device to the terminal device through a high-level signaling. Alternatively, the target carrier combination group may be determined by the terminal device based on a preset combination rule which may be specified by a communication protocol.

In an embodiment of the present disclosure, in case that a carrier combination includes multiple carriers, each carrier in the carrier combination may have a same sub-carrier spacing, and/or each carrier in the carrier combination may be configured with a same PUCCH group.

In an embodiment of the present disclosure, the target DCI may include carrier indication information, the carrier indication information may be for indicating the target carrier combination group, or the carrier indication information may be for indicating a target carrier combination in the target carrier combination group.

In an embodiment of the present disclosure, the carrier indication information may be determined through a CIF in the target DCI.

Alternatively, the carrier indication information may be determined through a target indication field in the target DCI. The target indication field and the CIF may be different information fields in the target DCI.

Alternatively, the carrier indication information may be determined through the CIF and the target indication field jointly.

In an embodiment of the present disclosure, the target indication field may be at least one of: a frequency domain resource allocation field, a time domain resource assignment field, a new data indicator field, or an HARQ process information field.

The specific limitation and beneficial effect of the method for PDCCH detection applied to the network device may be understood with reference to the embodiments of the method for PDCCH detection applied to the terminal device above and will not be elaborated herein again.

In an embodiment, as shown in FIG. 9, a terminal device is provided. The terminal device includes a detection module 900. The detection module 900 may be implemented as for example a detector.

The detection module 900 is configured to perform blind detection based on a PDCCH configuration sent by a network device, to obtain target DCI.

The PDCCH configuration corresponds to a target carrier combination group, the target carrier combination group includes one or more carrier combinations, and a carrier combination includes one or more carriers. The target DCI is for scheduling a carrier combination in the target carrier combination group.

In an embodiment of the present disclosure, the target carrier combination group may be configured by the network device to the terminal device through a high-level signaling.

Alternatively, the target carrier combination group may be determined by the terminal device based on a preset combination rule. The preset combination rule may be specified by a communication protocol.

In an embodiment of the present disclosure, in case that a carrier combination includes multiple carriers, each carrier in the carrier combination may have a same sub-carrier spacing, and/or each carrier in the carrier combination may be configured with a same PUCCH group.

In an embodiment of the present disclosure, the target DCI may include carrier indication information, the carrier indication information may be for indicating the target carrier combination group, or the carrier indication information may be for indicating a target carrier combination in the target carrier combination group.

In an embodiment of the present disclosure, the carrier indication information may be determined through a CIF in the target DCI.

Alternatively, the carrier indication information may be determined through a target indication field in the target DCI. The target indication field and the CIF may be different information fields in the target DCI.

Alternatively, the carrier indication information may be determined through the CIF and the target indication field jointly.

In an embodiment of the present disclosure, the target indication field may be at least one of: a frequency domain resource allocation field, a time domain resource assignment field, a new data indicator field, or an HARQ process information field.

In an embodiment of the present disclosure, the terminal device may further include an alignment module.

The alignment module is configured to perform alignment processing on all DCI formats in the PDCCH configuration based on the PDCCH configuration. Alternatively, the alignment module is configured to perform alignment processing on DCI formats for a same carrier combination in the PDCCH configuration based on the PDCCH configuration.

In an embodiment of the present disclosure, the alignment module is further configured to perform the alignment processing based on a preset alignment processing condition. The alignment processing condition may be that: the number of all DCI formats with different sizes within a current alignment processing range is greater than a numeral threshold, and there is no unaligned target type of DCI within the current alignment processing range. The target type of DCI herein is used for scheduling one carrier.

In an embodiment of the present disclosure, the terminal device may further include a determination module.

The determination module is configured to determine a PDCCH detection capability corresponding to the target carrier combination group.

In an embodiment of the present disclosure, the PDCCH detection capability may be a minimum between a maximum capability corresponding to the target carrier combination group and a total capability corresponding to a target parameter set. The target parameter set may be a parameter set of a scheduling carrier corresponding to the target carrier combination group.

In an embodiment of the present disclosure, the determination module is specifically configured to determine a total number of configured or activated groups of carrier combinations and a number of groups of carrier combinations of the target parameter set, and determine the total capability corresponding to the target parameter set according to the total number of the groups of carrier combinations and the number of the groups of carrier combinations of the target parameter set.

In an embodiment of the present disclosure, the determination module is specifically configured to determine an adjustment coefficient corresponding to each of configured or activated groups of carrier combinations, and determine the total capability corresponding to the target parameter set based on all adjustment coefficients, all the configured or activated groups of carrier combinations, and the groups of carrier combinations of the target parameter set.

In an embodiment of the present disclosure, the PDCCH detection capability may include a maximum number of candidate PDCCHs monitored by the terminal device and/or a maximum number of non-overlapped CCEs for channel estimation.

The implementation principle and technical effect of the terminal device provided by the above-mentioned embodiments are similar to that of the above-mentioned method embodiments and will not be elaborated herein again.

The specific limitation of the terminal device may be understood with reference to the embodiments of the method for PDCCH detection applied to the terminal device above and will not be elaborated herein again. Various modules in the terminal device may be implemented in whole or in part by software, hardware and combinations thereof. Various modules may be embedded in or independent of the processor in the communication device in the form of hardware, and may also be stored in the memory in the communication device in the form of software, so as to facilitate the processor to call the modules and execute the operations corresponding to the modules.

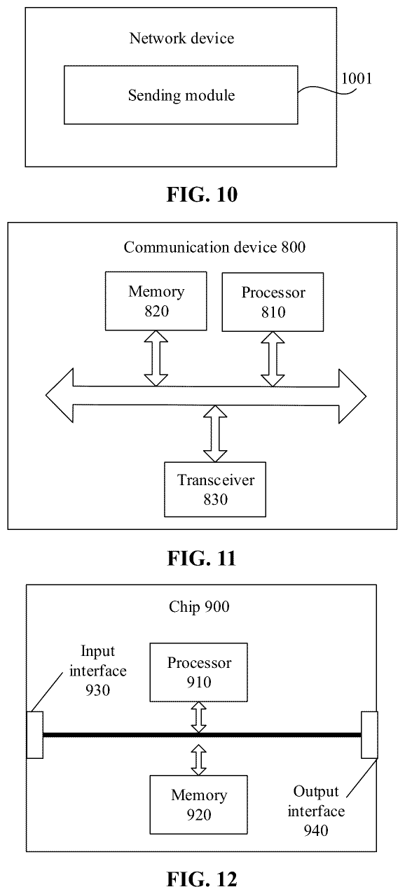

In an embodiment, as shown in FIG. 10, a network device is provided. The network device includes a sending module 1001. The sending module 1001 may be implemented as for example a transmitter.

The sending module 1001 is configured to send a PDCCH configuration for a target carrier combination group to a terminal device.

The PDCCH configuration corresponds to the target carrier combination group, the target carrier combination group includes one or more carrier combinations, and each carrier combination includes one or more carriers. The PDCCH configuration is configured for the terminal device to perform blind detection on the PDCCH based on the PDCCH configuration to obtain target DCI, and the target DCI is for scheduling a carrier combination in the target carrier combination group.

In an embodiment of the present disclosure, the target carrier combination group may be configured by the network device to the terminal device through a high-level signaling.

Alternatively, the target carrier combination group may be determined by the terminal device based on a preset combination rule. The preset combination rule may be specified by a communication protocol.

In an embodiment of the present disclosure, in case that a carrier combination includes multiple carriers, each carrier in the carrier combination may have a same sub-carrier spacing, and/or each carrier in the carrier combination may be configured with a same PUCCH group.

In an embodiment of the present disclosure, the target DCI may include carrier indication information, the carrier indication information may be for indicating the target carrier combination group, or the carrier indication information may be for indicating a target carrier combination in the target carrier combination group.

In an embodiment of the present disclosure, the carrier indication information may be determined through a CIF in the target DCI.

Alternatively, the carrier indication information may be determined through a target indication field in the target DCI. The target indication field and the CIF may be different information fields in the target DCI.

Alternatively, the carrier indication information may be determined through the CIF and the target indication field jointly.

In an embodiment of the present disclosure, the target indication field may be at least one of: a frequency domain resource allocation field, a time domain resource assignment field, a new data indicator field, or an HARQ process information field.

In an embodiment of the present disclosure, the network device may further include a configuration module.

The configuration module is configured to configure the PDCCH configuration for the target carrier combination group.

The implementation principle and technical effect of the network device provided by the above-mentioned embodiments are similar to that of the above-mentioned method embodiments and will not be elaborated herein again.

The specific limitation of the network device may be understood with reference to the embodiments of the method for PDCCH detection applied to the network device above and will not be elaborated herein again. Various modules in the network device may be implemented in whole or in part by software, hardware and combinations thereof. Various modules may be embedded in or independent of the processor in the communication device in the form of hardware, and may also be stored in the memory in the communication device in the form of software, so as to facilitate the processor to call the modules and execute the operations corresponding to the modules.

FIG. 11 is a schematic structural diagram of a communication device according to an embodiment of the disclosure. The communication device may be a terminal device and may also be a network device. The communication device 800 illustrated in FIG. 11 includes a processor 810. The processor 810 may be configured to call a computer program stored in a memory and run the computer program to perform the method according to the embodiments of the disclosure.

In some embodiments, as illustrated in FIG. 11, the communication device 800 may further include a memory 820. The processor 810 may be configured to call a computer program stored in the memory 820 and run the computer program to perform the method according to the embodiments of the disclosure.

The memory 820 may be a separate device independent from the processor 810, or may be integrated in the processor 810.

In some embodiments, as illustrated in FIG. 11, the communication device 800 may further include a transceiver 830. The processor 810 may control the transceiver 830 to communicate with other devices, specifically, to transmit information or data to other devices, or receive information or data from other devices.

The transceiver 830 may include a transmitter and a receiver. The transceiver 830 may further include an antenna, and there may be one or more antennas.

In some embodiments, the communication device 800 may perform corresponding flows that are implemented by the terminal device or network device in various methods of the embodiments of the disclosure. For brevity, details are not described herein again.

FIG. 12 is a schematic structural diagram of a chip according to an embodiment of the disclosure. The chip 900 illustrated in FIG. 12 includes a processor 910. The processor 910 may be configured to call a computer program stored in a memory and run the computer program to perform the method according to an embodiment of the disclosure.

In some embodiments, as illustrated in FIG. 12, the chip 900 may further include a memory 920. The processor 910 may be configured to call the computer program stored in the memory 920 and run the computer program to perform the method according to the embodiments of the disclosure.

The memory 920 may be a separate device independent from the processor 910, or may be integrated in the processor 910.

In some embodiments, the chip 900 may further include an input interface 930. The processor 910 may control the input interface 930 to communicate with other devices or chips, specifically, to obtain information or data from other devices or chips.

In some embodiments, the chip 900 may further include an output interface 940. The processor 910 may control the output interface 940 to communicate with other devices or chips, specifically, to output information or data to other devices or chips.

In some embodiments, the chip 900 may be applied to the communication device 800 in the embodiments of the disclosure. The chip 900 may perform corresponding flows that are performed by the terminal device or the network device in various methods of the embodiments of the disclosure. For brevity, details are not described herein again.

It should be understood that, the chip 900 mentioned in the embodiments of the disclosure may be also referred to as a system-level chip, a system chip, a chip system or a chip of a system on chip, etc.

It should be understood that, the processor in the embodiments of the disclosure may be an integrated circuit chip having a signal processing capability. During implementation, the steps of the foregoing method embodiments may be implemented by using a hardware integrated logic circuit in the processor or implemented by using instructions in a software form. The foregoing processor may be a general purpose processor, a digital signal processor (DSP), an application-specific integrated circuit (ASIC), a field programmable gate array (FPGA), or another programmable logical device, discrete gate or transistor logical device, or discrete hardware component. The processor may implement or perform methods, steps and logical block diagrams disclosed in the embodiments of the disclosure. The general purpose processor may be a microprocessor or the processor may be any conventional processor and the like. Steps of the methods disclosed with reference to the embodiments of the disclosure may be directly executed and completed by means of a hardware decoding processor, or may be executed and completed by using a combination of hardware and software modules in the decoding processor. The software module may be located in a mature storage medium in the field, such as a random access memory (RAM), a flash memory, a read-only memory (ROM), a programmable ROM (PROM), an electrically-erasable programmable memory, or a register. The storage medium is located in the memory, and the processor reads information in the memory and completes the steps in the foregoing methods in combination with hardware of the processor.

It can be understood that, the memory in the embodiments of the disclosure may be a volatile memory or a non-volatile memory, or may include both a volatile memory and a non-volatile memory. The non-volatile memory may be an ROM, a PROM, an erasable PROM (EPROM), an electrically EPROM (EEPROM) or a flash memory. The volatile memory may be an RAM and is used as an external cache. Through exemplary but not limited description, many forms of RAMs may be used, for example, a static RAM (SRAM), a dynamic RAM (DRAM), a synchronous DDRAM (SDRAM), a double data rate SDRAM (DDR SDRAM), an enhanced SDRAM (ESDRAM), a synch link DRAM (SLDRAM) and a direct rambus RAM (DR RAM). It should be noted that, the memory of the system and the method described herein aims to include but not be limited to these memories and any other suitable types of memories.

It should be understood that, the foregoing memory is exemplary but not limited description, for example, the memory in the embodiments of the disclosure may be an SRAM, a DRAM, an SDRAM, a DDR SDRAM, an ESDRAM, an SLDRA) and a DR RAM, etc. It should be noted that, the memory in the embodiments of the disclosure aims to include but not be limited to these memories and any other suitable types of memories.

An embodiment of the disclosure further provides a computer-readable storage medium configured to store a computer program.

In some embodiments, the computer-readable storage medium may be applied to the terminal device or the network device in the embodiments of the disclosure, and the computer program causes the terminal device or the network device to perform corresponding flows that are performed by the terminal device or the network device in various methods of the embodiments of the disclosure. For brevity, details are not described herein again.

An embodiment of the disclosure further provides a computer program product including a computer program.

In some embodiments, the computer program product may be applied to the terminal device or the network device in the embodiments of the disclosure, and the computer program instructions cause the terminal device or the network device to perform corresponding flows that are performed by the terminal device or the network device in various methods of the embodiments of the disclosure. For brevity, details are not described herein again.

An embodiment of the disclosure further provides a computer program.

In some embodiments, the compute program may be applied to the terminal device or the network device in the embodiments of the disclosure, and the computer program, when being run on the terminal device or the network device, causes the terminal device or the network device to perform corresponding flows that are performed by the terminal device or the network device in various methods of the embodiments of the disclosure. For brevity, details are not described herein again.

A person of ordinary skill in the art may be aware that, in combination with the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. Those skilled in the art may use different methods to implement the described functions for each particular application, but it should not be considered that the implementation goes beyond the scope of this application.

It may be clearly understood by those skilled in the art that, for the purpose of convenient and brief description, the detailed working process of the foregoing system, apparatus, and units may refer to the corresponding process in the foregoing method embodiments, and details are not described herein again.

In the several embodiments provided in this disclosure, it should be understood that the disclosed system, device, and method may be implemented in other schemes. For example, the described apparatus embodiments are merely exemplary. For example, the unit division is merely a logical function division and there may be other divisions in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical or other forms.

The units described as separate parts may be or may not be physically separate, and parts displayed as units may be or may not be physical units, they may be located in one position, or may be distributed on multiple network units. Some or all of the units may be selected according to actual needs to achieve the objectives of the solutions of the embodiments.

In addition, functional units in the embodiments of this disclosure may be integrated into one processing unit, or each of the units may exist alone physically, or two or more units are integrated into one unit.

When the functions are implemented in form of a software functional module and sold or used as an independent product, the functions may be stored in a computer-readable storage medium. Based on such an understanding, the technical solutions of this application essentially, or the part contributing to the prior art, or part of the technical solutions may be implemented in the form of a software product. The computer software product is stored in a storage medium, and includes several instructions for instructing a computer device (which may be a personal computer, a server, a network device, and the like) to perform all or a part of the steps of the method described in the embodiment of the disclosure. The foregoing storage medium includes: any medium that can store program codes, such as a USB flash disk, a removable hard disk, an ROM, an RAM, a magnetic disk, or an optical disk.

The foregoing descriptions are merely specific implementations of this application, but are not intended to limit the scope of protection of this application. Any variation or replacement readily figured out by a person skilled in the art within the technical scope disclosed in this application shall fall within the scope of protection of this application. Therefore, the scope of protection of this application shall be subject to the protection scope of the claims.

The term “and/or” in the disclosure is only an association relationship for describing the associated objects, and represents that three relationships may exist, for example, A and/or B may represent the following three cases: A exists separately, both A and B exist, and B exists separately. In addition, the character “/” in this specification generally indicates an “or” relationship between the associated objects.

1. A method for physical downlink control channel (PDCCH) detection, comprising:
performing, by a terminal device, blind detection based on a PDCCH configuration sent by a network device, to obtain target downlink control information (DCI),
wherein the PDCCH configuration corresponds to a target carrier combination group, the target carrier combination group comprises one or more carrier combinations, and each carrier combination comprises one or more carriers; and the target DCI is for scheduling a carrier combination in the target carrier combination group.

2. The method of claim 1, wherein the target carrier combination group is configured by the network device to the terminal device through a high-level signaling; or
the target carrier combination group is determined by the terminal device based on a preset combination rule.

3. The method of claim 1, wherein in case that the carrier combination comprises a plurality of carriers, each carrier in the carrier combination has a same subcarrier spacing, or each carrier in the carrier combination is configured with a same physical uplink control channel (PUCCH) group, or each carrier in the carrier combination has a same subcarrier spacing and is configured with a same PUCCH group.

4. The method of claim 1, wherein the target DCI includes carrier indication information, wherein the carrier indication information is for indicating the target carrier combination group, or the carrier indication information is for indicating a target carrier combination in the target carrier combination group.

5. The method of claim 4, wherein the carrier indication information is determined through a carrier indicator field (CIF) in the target DCI; or
the carrier indication information is determined through a target indication field in the target DCI, wherein the target indication field and the CIF are different information fields in the target DCI; or
the carrier indication information is determined through the CIF and the target indication field jointly.

6. The method of claim 1, further comprising:
performing, based on the PDCCH configuration, alignment processing on all DCI formats in the PDCCH configuration; or
performing, based on the PDCCH configuration, alignment processing on DCI formats for a same carrier combination in the PDCCH configuration.

7. The method of claim 1, further comprising:
determining a PDCCH detection capability corresponding to the target carrier combination group.

8. The method of claim 7, wherein the PDCCH detection capability is a minimum between a maximum capability corresponding to the target carrier combination group and a total capability corresponding to a target parameter set, wherein the target parameter set is a parameter set of a scheduling carrier corresponding to the target carrier combination group.

9. The method of claim 8, wherein
the total capability corresponding to the target parameter set is determined by operations of:
determining a total number of configured or activated groups of carrier combinations and a number of groups of carrier combinations of the target parameter set; and
determining the total capability corresponding to the target parameter set according to the total number of the groups of carrier combinations and the number of the groups of carrier combinations of the target parameter set,
or,
the total capability corresponding to the target parameter set is determined by operations of:
determining an adjustment coefficient respectively corresponding to each of configured or activated groups of carrier combinations, and determining the total capability corresponding to the target parameter set based on all adjustment coefficients, all the configured or activated groups of carrier combinations, and groups of carrier combinations of the target parameter set.

10. The method of claim 7, wherein the PDCCH detection capability comprises a maximum number of candidate PDCCHs monitored by the terminal device and/or a maximum number of non-overlapped control channel elements (CCEs) for channel estimation.

11. A terminal device, comprising:
a processor; and
a detector, configured to perform blind detection under control of the processor based on a physical downlink control channel (PDCCH) configuration sent by a network device, to obtain target downlink control information (DCI),
wherein the PDCCH configuration corresponds to a target carrier combination group, the target carrier combination group comprises one or more carrier combinations, and each carrier combination comprises one or more carriers; and the target DCI is for scheduling a carrier combination in the target carrier combination group.

12. The terminal device of claim 11, wherein the target carrier combination group is configured by the network device to the terminal device through a high-level signaling; or
the target carrier combination group is determined by the terminal device based on a preset combination rule.

13. The terminal device of claim 11, wherein in case that the carrier combination comprises a plurality of carriers, each carrier in the carrier combination has a same subcarrier spacing, or each carrier in the carrier combination is configured with a same physical uplink control channel (PUCCH) group, or each carrier in the carrier combination has a same subcarrier spacing and is configured with a same PUCCH group.

14. The terminal device of claim 11, wherein the target DCI includes carrier indication information, wherein the carrier indication information is for indicating the target carrier combination group, or the carrier indication information is for indicating a target carrier combination in the target carrier combination group.

15. The terminal device of claim 14, wherein the carrier indication information is determined through a carrier indicator field (CIF) in the target DCI; or
the carrier indication information is determined through a target indication field in the target DCI, wherein the target indication field and the CIF are different information fields in the target DCI; or
the carrier indication information is determined through the CIF and the target indication field jointly.

16. The terminal device of claim 11, wherein the processor is configured to:
perform, based on the PDCCH configuration, alignment processing on all DCI formats in the PDCCH configuration; or
perform, based on the PDCCH configuration, alignment processing on DCI formats for a same carrier combination in the PDCCH configuration.

17. The terminal device of claim 11, wherein the processor is configured to determine a PDCCH detection capability corresponding to the target carrier combination group.

18. The terminal device of claim 17, wherein the PDCCH detection capability is a minimum between a maximum capability corresponding to the target carrier combination group and a total capability corresponding to a target parameter set, wherein the target parameter set is a parameter set of a scheduling carrier corresponding to the target carrier combination group.

19. A network device, comprising:
a processor; and
a transceiver, connected to the processor and configured to send a physical downlink control channel (PDCCH) configuration for a target carrier combination group to a terminal device,
wherein the PDCCH configuration corresponds to the target carrier combination group, the target carrier combination group comprises one or more carrier combinations, and each carrier combination comprises one or more carriers; and the PDCCH configuration is configured for the terminal device to perform blind detection on a PDCCH based on the PDCCH configuration to obtain target downlink control information (DCI), and the target DCI is for scheduling a carrier combination in the target carrier combination group.

20. The network device of claim 19, wherein the target carrier combination group is configured by the network device to the terminal device through a high-level signaling; or
the target carrier combination group is determined by the terminal device based on a preset combination rule.
